(19) United States
(12) Patent Application Publication
(10) Pub. No.: US 2012/0262292 A1
(43) Pub. Date: Oct. 18, 2012

(54) PORTABLE DEVICE INVENTORY TRACKING

(76) Inventor: MARTIN MOSER, Speyer (DE)

(21) Appl. No.: 13/086,432

(22) Filed: Apr. 14, 2011

(51) Int. Cl. G08B 21/00

(52) U.S. Cl. 340/540

(57) ABSTRACT

Various embodiments of systems and methods for portable device inventory tracking are described herein. In various embodiments, a mother device scans a vicinity to register and track one or more satellite devices. During registration process, the mother device assigns an owner identifier value and an item identifier value to the satellite device and a user can save which satellite device to register. One or more rules can be configured to determine when a reachability request is to be sent to the one or more satellite devices. A method of an embodiment ensures that if a satellite device does not respond to the reachability request, an alert message can be generated on the mother device. The alert message can be prioritized and can consist of a log entry with detailed information about the alert or a time stamp and location of the last reachability request acknowledgement sent from the satellite device.

### FIELD

The field generally relates to inventory tracking, and more specifically to systems and methods for portable device inventory tracking.

### BACKGROUND

People are always loosing and dropping important and precious items everyday throughout their lives. Many people tend to drop their wallets after paying at the grocery store, leaving their purse behind in a dressing room, and losing other such essential items at inappropriate places. Such items are often of great importance and their contents can sometimes be more valuable than the item lost. In other situations, people can tend to misplace their set of keys to their house, forget where they have parked their car in an enormous parking lot at a shopping mall, or even misplace a second mobile phone that they frequently use. There is always a need to track personal belongings, so that if they are lost, they can be found again.

In addition to tracking personal belongings, one may wish to track business data stored on a portable device. A nurse may wish to track that a correct dosage of medicine is given to a correct patient at a precise time. At an auto repair shop, a mechanic may wish to track which cars have had their oil changed, the quantity of oil that each car had received, and the time that the oil change was completed as they are walking around inspecting the shop. As businesses begin to use portable devices to monitor their inventory and work processes, the tracking of business data from remote locations will also be of importance and vital to increase productivity.

### SUMMARY

Various embodiments of systems and methods for portable device inventory tracking are described herein.

Described herein are methods and systems for portable device inventory tracking. In one aspect, a mother device scans a vicinity for one or more satellite devices to be registered. The mother device receives an acknowledgement from the one or more satellite devices. In yet another aspect, the one or more discovered satellite devices are presented on the mother device. Once displayed, the one or more satellite devices are registered on the mother device. In a further aspect, a test for reachability is performed periodically for the one or more satellite devices registered on the mother device. If the one or more registered satellite devices do not respond to a reachability request, an alert message is generated on the mother device indicating that the satellite is out of reach.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a mother device scanning a vicinity for one or more satellite devices to be registered on the mother device according to various embodiments.

FIG. 2 is a block diagram illustrating a communication process between a mother device and a satellite device according to various embodiments.

FIG. 3 is a block diagram illustrating a mother device tracking business data stored on a satellite device according to various embodiments.

FIG. 4 is a flow diagram illustrating an exemplary method of a portable device inventory tracking according to various embodiments.

FIG. 5 is a flow diagram illustrating an exemplary method of registering a satellite device and testing for reachability of the satellite device according to various embodiments.

FIG. 6 is a block diagram of an exemplary computer system according to various embodiments.

### DETAILED DESCRIPTION

Embodiments of techniques for portable device inventory tracking are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

In various embodiments, the system and method for portable device inventory tracking allows registering a plurality of satellite devices onto a mother device and track the satellite devices from the mother device using a Radio Frequency Identification (RFID), Bluetooth, infrared, or other such current and near future technologies for communication channels between portable devices. A mother device and a satellite device may comprise electronic portable devices, such as an electronic notepad, a mobile phone, a GPS receiver, and the like, with integrated electronic transceivers that have the means of emitting and receiving electronic carrier waves in order to establish a communication channel with another electronic device. A satellite device may also comprise of separate electronic transceivers attached to personal belongings that are contained within for similar tracking purposes.

Satellite devices may be manually registered (i.e. checked in) and deregistered (i.e. checked out) by a user or may be configured to automatically register or deregister. The mother device may also track business data stored on a satellite device. For example, a satellite device may be an electronic notepad, an e-book, a mobile phone, or other such portable devices. In the line of business of medicine, for example, such portable devices may store business data of the name and quantity of medicine that each patient should be administered, when the medicine was administered, and at what time. This business data may be transmitted from a satellite device to the mother device, therefore tacking the stored business data.

In various embodiments, one or more set of rules can be configured to check reachability of a satellite device registered on the mother device. For example, if the satellite device tends to be stationary, such as an electronic transceiver attached to an automobile parked in a parking lot for some time, then the rule can be configured to check its reachability less often or only at certain time intervals. If a satellite device does not respond to a reachability request, an alert message can be generated to notify the user that the satellite device is not within reach. The alert message can consist of a timestamp and a location of a last successfully received reachability request acknowledgement from the satellite device. The location is received by the use of a Global Positioning System (GPS) receiver or some similar technology for global positioning. In conjunction with some type of GPS software or the like, the mother device can display step by step directions to the location of where the last reachability request acknowledgement was successfully received.

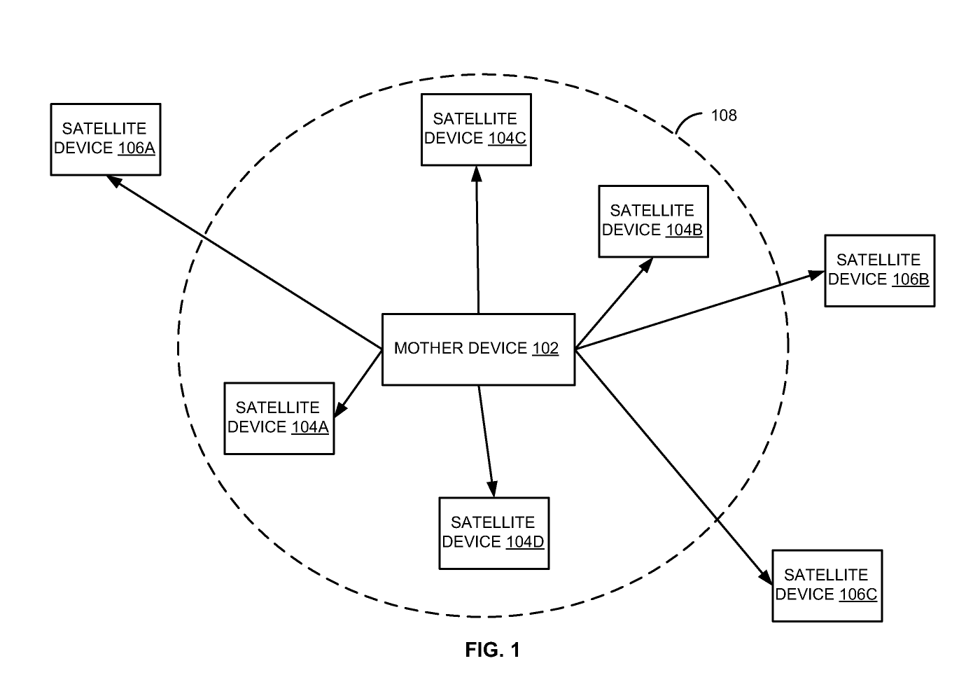

FIG. 1 is a block diagram illustrating a mother device scanning a vicinity for one or more satellite devices (e.g., 104A-D) to be registered on the mother device according to various embodiments. Referring to FIG. 1, a portable device for inventory tracking comprise a mother device 102, which scans the vicinity for satellite devices 104 A-D and 106A-C in order to establish a communication channel. Radio Frequency Identification (RFID), Bluetooth, infrared, or other such current technologies can be used to configure a signal range 108 to be recognized by the satellite devices (e.g., 104 A-D and 106A-C). The technology being used and its capabilities will influence the signal strength that the mother device 102 emits and the distance that it reaches. If a satellite device (e.g., 104 A-D) is within range 108 of the mother device 102, then a connection and tracking process may be established. If the satellite device (e.g., 106 A-C) is out of range 108 of the mother device 102 then a connection cannot be made as it is not within the range capabilities of the mother device 102.

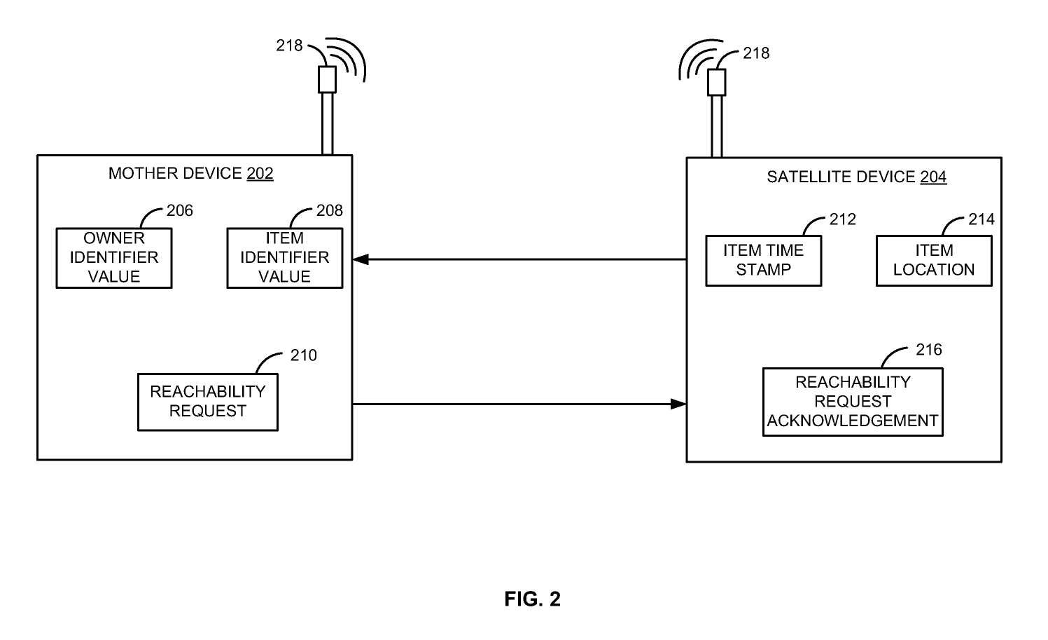

FIG. 2 is a block diagram illustrating a communication process between a mother device 202 and a satellite device 204 according to various embodiments. Once a communication channel is established between the mother device 202 and the satellite device 204 through the use of a transceiver 218, a registration process can begin. The mother device 202 assigns an owner identifier value 206 and an item identifier value 208 to the satellite device 204. The owner identifier value 206 is a value to indicate to the satellite device 204 which mother device 202 it is registered to. The item identifier value 208 is a unique number that is given by the mother device 202 to indicate its authenticity in a list of registered satellite devices. An item identifier value 208 can be incremental.

For example, a within range satellite device 204 may be a mobile phone that is given an item identifier value of 23001 by the mother device 202. If a second mobile phone is registered on the mother device 202, it will be assigned the value of 23002.

Once a registration process has been successfully completed, the mother device 202 may send out a reachability request 210 to the registered satellite device 204 to determine whether it is within communication range. If within range, the satellite device 204 may respond with a reachability request acknowledgement 216 confirming that the initial reachability request 210 sent from the mother device 202 has been received. Along with the reachability request acknowledgement 216, an item time stamp 212 and an item location 214 may also be sent out by the satellite device 204. The item time stamp 212 is the date and time in which the satellite device 204 has received the last successful reachability request 210. In conjunction with a GPS receiver, an item location 214 can indicate the location of the last received reachability request acknowledgement 216 successfully sent from the satellite device 204.

Furthermore, if the satellite device 204 does not include a GPS receiver, the location of the mother device 202 can be used as a location for the satellite device 204 if the reachability request acknowledgement 216 has been received by the mother device 202. The assumption is that the satellite device 204 is within communication range of the mother device 202, therefore they both share a similar location. As not every satellite device 204 has a GPS receiver, this method can take advantage of lower hardware costs for the inventory tracking process between a mother device 202 and a satellite device 204.

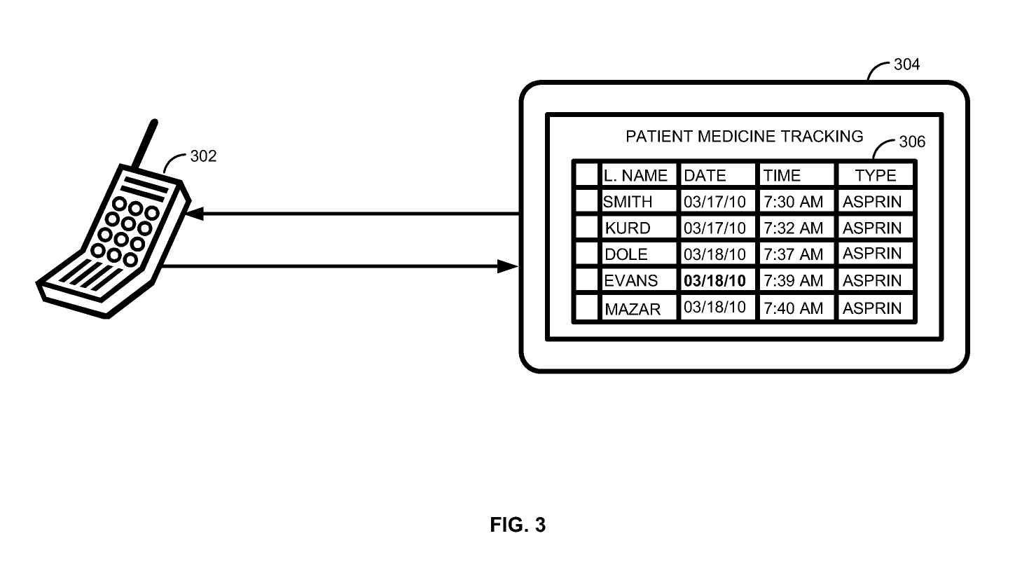

FIG. 3 is a block diagram illustrating a mother device tracking business data stored on a satellite device according to various embodiments. Referring to FIG. 3, a mother device for inventory tracking may consist of a mobile phone 302, while a satellite device may consist of an electronic notepad 304. When a communication channel is established, the mobile phone 302 may communicate with the electronic notepad 304 to download business data 306 that has been stored on the electronic notepad 304. In the example, the business data may be data about tracking medicine that has been administered to patients at a local hospital. Business data such as, the name, date, time, and type of medicine can be accessed by the mobile phone 302 and download on the local storage device of the mother device. A user may then view this data or wish to upload it onto a database or server for collaboration purposes. The user can also configure a set of rules of when to transfer business data between the mobile phone 302 and the electronic notepad 304. For example, a configured rule may be a certain time interval, a certain amount of transfers per hour, and other such similar rules.

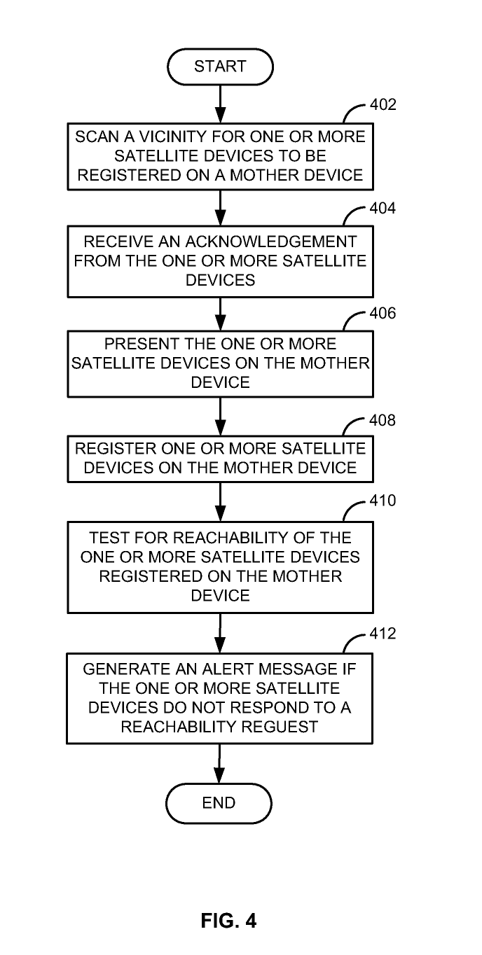

FIG. 4 is a flow diagram illustrating an exemplary method of a portable device inventory tracking according to various embodiments. Referring to FIG. 4, at process block 402, a mother device scans a vicinity for one or more satellite devices to be registered. The mother device can use Radio Frequency Identification (RFID), Bluetooth, infrared, or other such current and near future technologies for mobile communication to establish a connection. The mother device then receives an acknowledgement from the one or more satellite devices, as in process block 404. The one or more satellite devices are presented on the mother device, as in process block 406, and a user can choose to register one or more satellite devices on the mother device, as in process block 408. In process block 410, a periodical test for reachability of the one or more satellite devices registered on the mother device can be performed. An alert message is generated if the one or more satellite devices do not respond to a reachability request, as in process block 412.

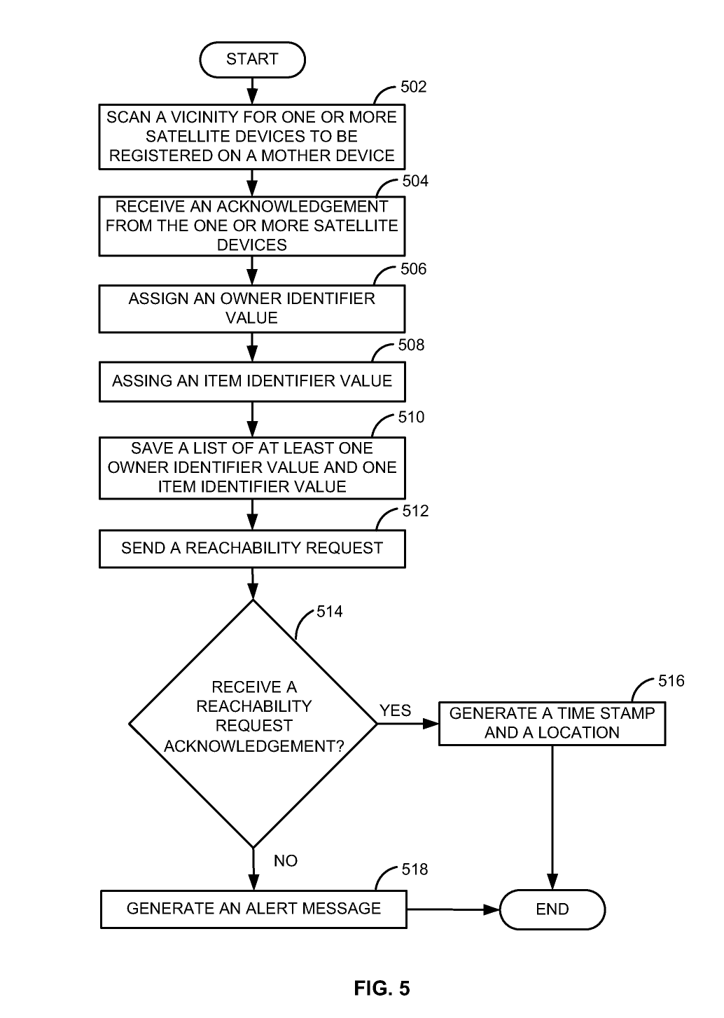

FIG. 5 is a flow diagram illustrating an exemplary method of registering a satellite device and testing for reachability of the satellite device according to various embodiments. Referring to FIG. 5, a mother device scans a vicinity for one or more satellite devices to be registered, as in process block 502. When the mother device receives an acknowledgement from the one or more satellite devices, as in process block 504, it assigns an owner identifier value, as in process block 506, and assigns an item identifier value, as in process block 508 to each registered satellite device. A list of satellite devices are presented on the mother device and a user can save the satellite devices that he or she wishes to be registered.

When registering, a user is saving at least one owner identifier value and one item identifier value, as in process block 510, assigned to the satellite device. For example, in the case of registering a mobile phone, the assigned owner identifier value and the item identifier value are saved on the mother device. In the case of registering two mobile phones, the owner identifier value may be the same for both phones, but the item identifier values may be similar in value, but with an increment of one, for instance. Satellite devices can be registered (i.e. checked-in) or deregistered (i.e. checked-out) manually by the user or can be configured to automatically. A user can configure the mother device to determine when to automatically register or deregister a satellite device.

The mother device can send a reachability request to the registered satellite devices, as in process block 512. The reachability request can be configured to be sent out a number of different ways. For instance, at certain time intervals, a certain amount of requests per a specific time period, and other such rules. Once a request has been sent, a reachability request acknowledgement is expected from the satellite device. If a reachability request acknowledgement has been received, as in process block 514, then a time stamp and location is generated, as in process block 516. If a reachability request 512 has not been acknowledged by one or more satellite devices then an alert message is generated, as in process block 518. An alert message can be preconfigured to be prioritized based on importance (i.e. low, medium, and high). For example, when tracking a satellite device, such as an electronic transceiver attached to a wallet, the wallet can be of higher importance that a set of car keys to an automobile. An alert message can also consist of a log entry that displays more detailed information about the alert itself, or can be a time stamp and a location of the last reachability request acknowledgement successfully sent from the satellite device.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

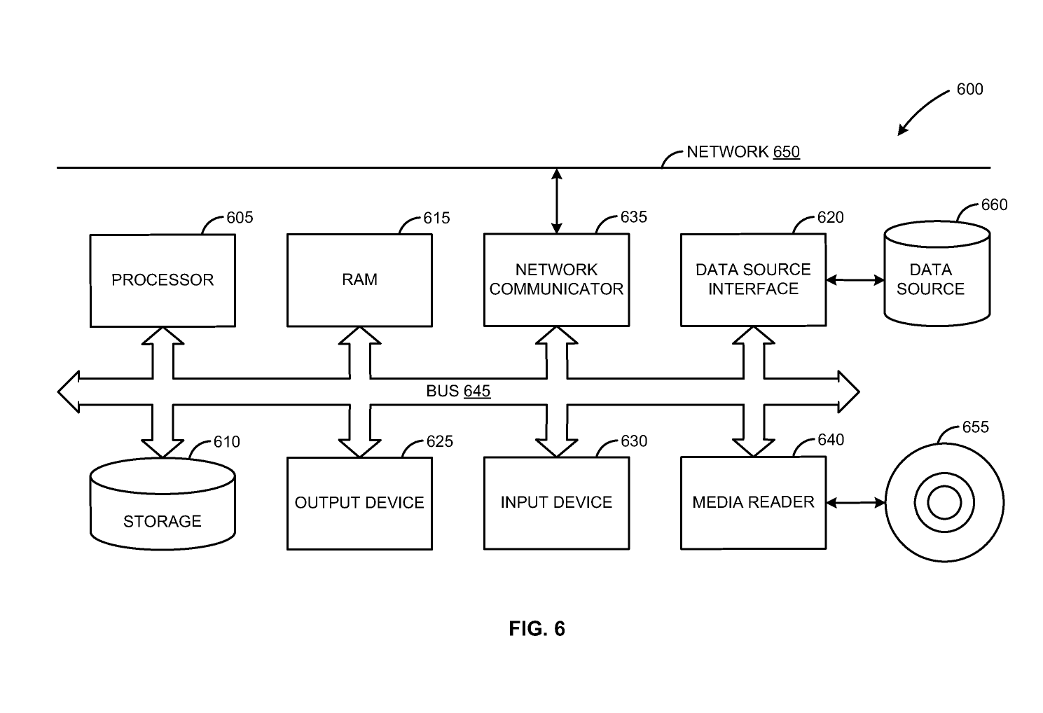

FIG. 6 is a block diagram of an exemplary computer system 600. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a tangible computer readable storage medium to physically store instructions, which when executed by a computer, cause the computer to:
scan a vicinity of a mother device for one or more satellite devices to be registered on the mother device;
receive an acknowledgement from the one or more satellite devices;
present the one or more satellite devices on the mother device;
register the one or more satellite devices with the mother device;
test for reachability of the one or more satellite devices registered on the mother device; and
generate an alert message if at least one of the one or more satellite devices do not respond to a reachability request.

2. The article of manufacture of claim 1, wherein receiving an acknowledgement from the plurality of satellite devices comprises:
assigning an owner identifier value to the one or more satellite devices; and
assigning an item identifier value to the one or more satellite devices.

3. The article of manufacture of claim 1, wherein registering the one or more satellite devices comprises saving a list of at least one owner identifier value and at least one item identifier value.

4. The article of manufacture of claim 1, wherein testing for reachability further comprises sending a reachability request to be acknowledged by the one or more satellite devices registered on the mother device.

5. The article of manufacture of claim 4, further comprising sending the reachability request according to at least one rule configured on the mother device.

6. The article of manufacture of claim 4, further comprising receiving a reachability request acknowledgement comprising a time stamp and a location.

7. The article of manufacture of claim 6, further comprising displaying a set of directions in conjunction with the location of the one or more satellite devices registered on the mother device.

8. A computer implemented method for mobile inventory tracking, the method comprising:
scanning a vicinity of a mother device for one or more satellite devices to be registered on the mother device;
receiving an acknowledgement from the one or more satellite devices;
presenting the one or more satellite devices on the mother device;
registering the one or more satellite devices on the mother device;
testing for reachability of the one or more satellite devices registered on the mother device; and
generating an alert message if at least one of the one or more satellite devices do not respond to a reachability request.

9. The method of claim 8, wherein receiving an acknowledgement from the plurality of satellite devices item further comprises:
assigning an owner identifier value to the one or more satellite devices; and
assigning an item identifier value to the one or more satellite devices.

10. The method of claim 8, wherein registering the one or more satellite devices comprises saving a list of at least one owner identifier value and at least one item identifier value.

11. The method of claim 8, wherein testing for reachability comprises sending a reachability request to be acknowledged by the one or more satellite devices registered on the mother device.

12. The method of claim 11, further comprising configuring at least one rule for when to send the reachability request.

13. The method of claim 11, further comprising receiving a reachability request acknowledgement, wherein the reachability request acknowledgement containing a time stamp and a location.

14. The method of claim 13, further comprising displaying a set of directions in conjunction with the location of the one or more satellite devices registered on the mother device.

15. A computer system device network comprising:
a mother device configured to:
scan its vicinity for one or more satellite devices to be registered on the mother device;
send a reachability request from the mother device to test reachability of the one or more satellite devices; and
generate an alert message if at least one of the one or more satellite devices do not respond to the reachability request by sending a reachability request acknowledgement; and
the one or more satellite devices configured to:
self register on the mother device by responding to the scan by the mother device; and
send the acknowledgement in response to receiving the reachability request by the mother device.

16. The computer system of claim 15, wherein the mother device is further configured to receive a time stamp and a location of a last received reachability request acknowledgement of the one or more satellite devices.

17. The computer system of claim 15, wherein the mother device is configured to assign an owner identifier value and an item identifier value to initiate a registration process.

18. The computer system of claim 16, wherein the mother device is configured to display a set of directions in conjunction with the location of the satellite device registered on the mother device.

19. The computer system of claim 15, wherein the mother device comprises a portable device with an electronic signals transceiver to establish a communication channel.

20. The computer system of claim 15, wherein the satellite device comprises a portable device with a electronic signals transceiver to establish a communication channel.
